(19) United States
(12) Patent Application Publication
(10) Pub. No.: US 2026/0036814 A1
(43) Pub. Date: Feb. 5, 2026

(54) SPLITTER AND COUPLING PRISM ARRANGEMENT

(71) Applicant: Lumus Ltd., Ness Ziona (IL)

(72) Inventors: Yochay DANZIGER, Kfar Vradim (IL); Ronen CHRIKI, Lod (IL); Eitan RONEN, Rechovot (IL)

(73) Assignee: Lumus Ltd., Ness Ziona (IL)

(21) Appl. No.: 19/100,159

(22) PCT Filed: Aug. 30, 2023
(86) PCT No.: PCT/IB2023/058574

§ 371 Date: Jan. 31, 2025

Related U.S. Application Data
(60) Provisional application No. 63/402,516, filed on Aug. 31, 2022.
(60) Provisional application No. 63/403,317, filed on Sep. 2, 2022.
(60) Provisional application No. 63/407,233, filed on Sep. 16, 2022.

(51) Int. Cl. G02B 27/01; G02B 6/34

(52) U.S. Cl. CPC G02B 27/0172; G02B 6/34

(57) ABSTRACT

An optical system may include a light-guide having a light input and mutually-parallel first and second major external surfaces for guiding the light by internal reflection, a projector configured to project light corresponding to an image from an aperture, the light exiting the aperture with a chief ray defining an optical axis of the projector and with an angular field about the chief ray, and a prism disposed adjacent the light input and having an image injection surface and a partially reflective surface parallel to the first and second major external surfaces, the projector being associated with the image injection surface and oriented such that the chief ray and at least some of the angular field about the chief ray are injected through the image injection surface, some rays corresponding to the angular field partially reflected and some partially transmitted by the partially reflective surface prior to entering the light-guide.

### FIELD OF THE INVENTION

The present disclosure relates to the field of near eye display optical systems such as head-mounted displays. More specifically, the present disclosure relates to reducing the size of near eye display optical systems by employing a splitter and coupling prism arrangement.

### BACKGROUND OF THE INVENTION

Consumer demands for improved human-computer interfaces have led to an increased interest in high-quality image head-mounted displays (HMDs) or near-eye displays (NED), commonly known as smart glasses. These devices can provide virtual reality (VR) or augmented reality (AR) experiences, enhancing the way users interact with digital content and their surrounding environment.

Consumers are seeking better image quality, immersive experiences, and greater comfort when using HMDs. They expect displays with high resolution, vibrant colors, and minimal distortion to create a realistic and enjoyable viewing experience. Additionally, comfort is a crucial factor since users often wear these devices for extended periods. Consumers desire lightweight, sleek designs that are less obtrusive and more convenient to wear in various scenarios. Smaller devices also offer improved portability, making them easier to carry and use in different environments. As such, there is a growing demand for higher performing yet smaller and more compact HMDs.

A critical element of the near-eye display systems is the projector. In the context of HMDs and NEDs, an image projector is a device that generates and projects visual content onto an intermediate medium (i.e., lightguide) to be delivered to the eye. The goal is to provide the user with the perception of images or videos, often with the illusion of depth or three-dimensionality. In the realm of HMDs and NEDs, the size of the image projector can be influenced by the entrance pupil into the lightguide. Ideally, for compactness and efficiency, both the projector and the entrance pupil of the lightguide should be small.

Technology behind projectors for HMDs and NEDs include LED, OLED, and Liquid Crystal on Silicon (LCoS) among others. A projector technology gaining in popularity involves laser projectors. Laser projectors in near-eye displays (NEDs) utilize laser light sources to generate and project images. While they offer several advantages such as high brightness, wide color gamut, compactness, low power consumption, etc., there are also some challenges associated with their use such as, for example, their susceptibility to generating coherent interference patterns.

### SUMMARY OF THE INVENTION

In near-eye displays, the geometrical relationship between the entrance pupil of a lightguide and the size of the image projector is crucial. The entrance pupil's size directly influences the projector's size, and a smaller entrance pupil is desirable for a more compact projector. In conventional lightguides, the pupil dimensions are approximately twice the thickness of the lightguide. The current disclosure presents enhanced optical systems that provide for reduced pupil dimension by employing a splitter and coupling prism arrangement.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a schematic diagram of an exemplary optical system incorporating a splitter and coupling prism arrangement.

FIGS. 2A, 2B, and 2C illustrate schematic diagrams of the optical system of FIG. 1 showing different angles on beams entering the optical system.

FIG. 3 illustrates a schematic diagram of an exemplary optical system incorporating a splitter and coupling prism arrangement.

FIG. 4 illustrates an example process of manufacturing optical systems.

FIG. 5 illustrates a schematic diagram of an exemplary optical system incorporating a splitter and coupling prism arrangement.

FIG. 6 illustrates a schematic diagram of an exemplary optical system incorporating a splitter and coupling prism arrangement.

FIGS. 7A and 7B illustrate schematic diagrams of an exemplary optical system incorporating a splitter and coupling prism arrangement.

FIG. 7C illustrates a schematic diagram of an exemplary optical system incorporating a splitter and coupling prism arrangement.

FIGS. 7D and 7E illustrate schematically alternative constructions for various prisms and splitters as disclosed.

FIG. 8 illustrates a schematic diagram of an exemplary optical system incorporating two splitters and a coupling prism.

FIG. 9 illustrates a schematic diagram of an exemplary optical system incorporating a coupling prism with multiple splitter surfaces built therein.

FIGS. 10A and 10B illustrate schematic diagrams of an exemplary optical system incorporating a coupling prism and a splitter with multiple splitting surface built therein.

FIGS. 11A-11C illustrate diagrams of an exemplary optical system incorporating a splitter and coupling prism arrangement.

FIGS. 12A-12D illustrate prior art optical systems.

FIGS. 13A-13D illustrate diagrams of exemplary optical systems incorporating a splitter and coupling prism arrangement.

### DETAILED DESCRIPTION

In near-eye displays, the geometrical relationship between the entrance pupil of a lightguide and the size of the image projector is crucial. The entrance pupil's size directly influences the projector's size, and a smaller entrance pupil is desirable for a more compact projector. In conventional lightguides, the pupil dimensions are approximately twice the thickness of the lightguide. The current disclosure presents enhanced optical systems that provide for reduced pupil dimension.

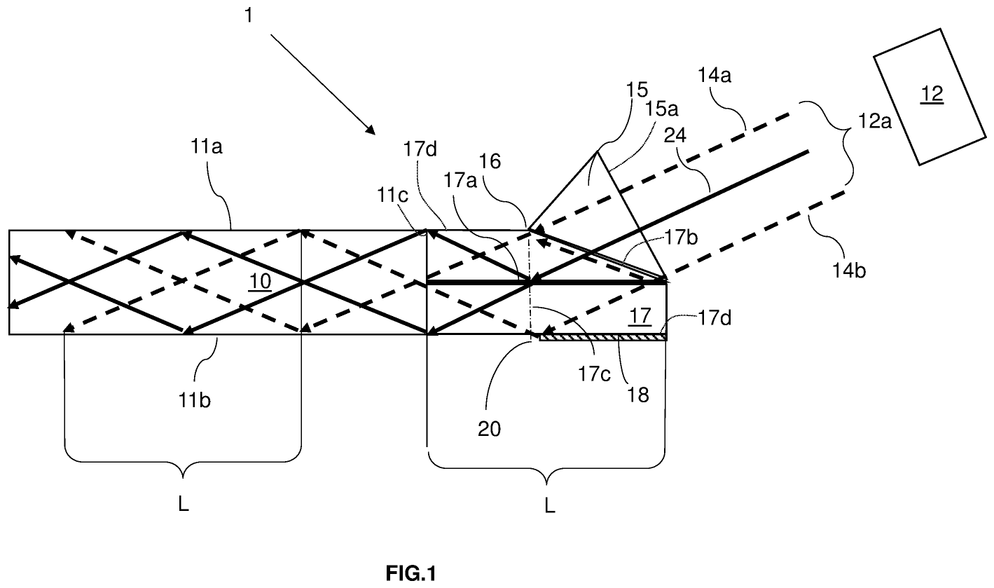

FIG. 1 illustrates a schematic diagram of an exemplary optical system 1.

System 1 includes a light-guide optical element (LOE) 10, typically formed from transparent material. LOE 10 has mutually-parallel first and second major external surfaces 11a, 11b for guiding light therein by internal reflection. LOE 10 may also include a light input 11c through which light enters the LOE 10.

System 1 also includes a beam splitter 17 disposed adjacent to the light input 11c of the LOE 10. The beam splitter 17 has a partially reflective surface 17a, which is parallel to the first and second major external surfaces 11a, 11b of the LOE 10. The beam splitter 17 also has a coupling-in surface 17b through which light enters the beam splitter 17.

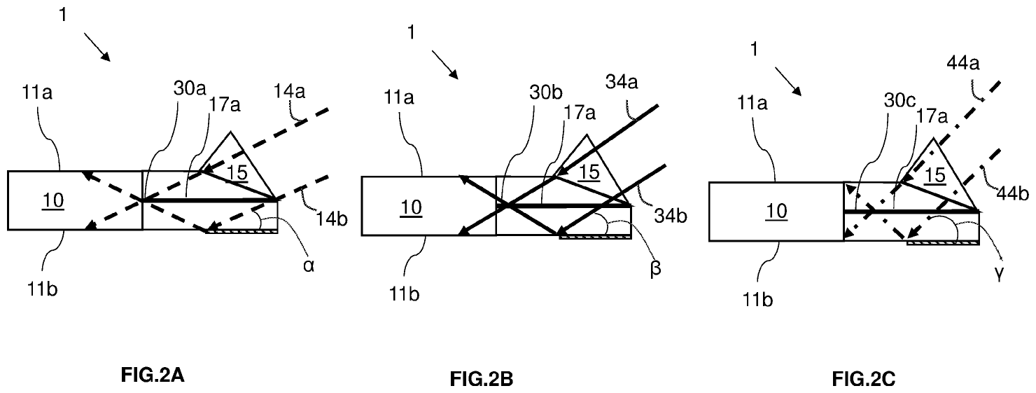

System 1 also includes a projector 12 that projects light corresponding to an image (for example, a collimated image) and has a beam width 12a, the beam width of one collimated beam. Projector 12 may be, for example, a laser projector. The beam 12a has a chief ray 24 defining an optical axis of the projector 12 and corresponding to a point in the image. The projected light also has an angular field about the chief ray 24 corresponding to other points in the image. The system has an aperture 17c. All collimated beams of the image cross aperture 17c. Aperture 17c is the exit-aperture of the laser system and, at the same time, it is the entrance aperture to the waveguide 10. FIG. 2 below describes various angles of the field, all passing through aperture 17c. The size of projector 12 is not to scale.

System 1 also includes a coupling prism 15 that has an image injection surface 15a. Projector 12 projects light corresponding to the image to be injected into prism 15 via the image injection surface 15a. The injected beams (represented by the two extremes beams 14a and 14b) impinge on the image injection surface 15a of prism 15. The chief ray 24 impinges on the image injection surface 15a perpendicularly, thereby minimizing aberrations. Rays corresponding to the angular field similarly enter prism 15 via the image injection surface 15a. This light travels through prism 15 to the coupling-in surface 17b of the beam splitter 17.

The partially reflecting surface 17a of the beam splitter 17 transmits a portion (e.g., 50%) and reflects a portion (e.g., 50%) of the light impinging thereon as described in, for example, PCT International Phase App. Pub. No. WO2021001841A1. In this embodiment, the partially reflecting surface 17a is designed to have a length such that every light ray of the shallowest angle light in the angular field entering through the coupling-in surface 17b strikes the partially reflective surface 17a of the beam splitter 17 exactly once prior to entering the LOE 10 via the light input 11c to propagate within the LOE 10 by internal reflection. Having the beam splitter 17 effectively split the injected light by a factor of two, doubles illumination into the LOE 10 and thereby requires smaller projecting optics into lightguide 10, reducing size. Therefore, ideally, the partially reflecting surface 17a is long enough that every light ray impinges upon the partially reflecting surface 17a. However, if the partially reflecting surface 17a is too long, light rays that were previously split may strike the partially reflecting surface a second time and recombine, resulting in undesirable interference. In system 1, the rays which split after first impinging on surface 17a do not impinge a second time on the surface. In effect, the length of the partially reflective surface 17a of the beam splitter 17 is such that a majority of light rays in the angular field transmitted through the coupling-in surface 17b impinge on the partially reflective surface 17a exactly once prior to entering the LOE so as to propagate within the LOE by internal reflection. Therefore, surface 17a acts as a splitter and not as a combiner. Consequently, coherent light can be injected into the lightguide without risk of generating coherent interference patterns.

System 1 may also include a light absorber 18 that trims excess light at one end of the range between 14a and 14b. The light absorber 18 is adjacent to a surface 17d of the beam splitter 17 opposite the coupling-in surface 17b. Trim location 20 (corresponding to the end of light absorber 18) is located directly opposing corner 16, which trims excess light at the other end of the range between 14a and 14b. Therefore, corner 16 and trim location 20 perform symmetrical trimming of the transmitted beams. In effect, a virtual plane 17c is formed between corner 16 and location 20, defining the entrance pupil into LOE 10.

FIGS. 2A, 2B, and 2C illustrate schematic diagrams of the optical system 1 showing different angles on beams entering the optical system 1 all overlapping when crossing surface 17c, the entrance aperture to the waveguide 10. FIG. 2A illustrates the shallowest angle α relative to the first and second major surfaces 11a, 11b, FIG. 2C illustrates the steepest angle γ relative to the first and second major surfaces 11a, 11b, and FIG. 2B illustrates an angle therebetween β. Here α<β<γ relative to the first and second major surfaces 11a, 11b. It is apparent from these illustrations that the optimal length of partially reflecting surface 17a is different for the different field angles. In FIG. 2A, the length of the partially reflecting surface 17a is set to maximize beam splitting while minimizing interference for the shallowest angle represented by the rays 14a, 14b. In FIG. 2A, any overlap at 30a (i.e., the end of the partially reflecting surface 17a) between the extreme rays 14a, 14b is minimized. However, in FIG. 2B and FIG. 2C, there is significant overlap (at 30b and 30c) between rays 34a, 34b and rays 44a, 44b, which corresponds to undesired length of the partially reflecting surface 17a for these steeper angled rays. Practically, the length of surface 17a is a compromise: if too long, then some interference would be expected, caused by recombining at 30b and 30c. However, if the length of the partially reflecting surface 17a is set too short, then some illumination non-uniformities would be expected caused by lack of beam splitting.

In determining the length of partially reflective surface 17a, a compromise may correspond to maximizing beam splitting to ensure uniform illumination while minimizing interference caused by recombination as much as possible. This is the equivalent of optimizing for the shallowest angle light, as shown in FIGS. 1 and 2A. With this goal in mind, it can be seen from FIG. 1 that the appropriate length L for the partially reflecting surface 17a may be approximately equal to half a total internal reflection round trip for ray 14b. Thus, the length L for the partially reflecting surface 17a may be set to approximately equal to the length L of the LOE 10 in which light from the light ray 14b (i.e., the light ray of the most oblique (i.e., shallowest) angle light in the angular field that enters through the coupling-in surface 17b farthest away from the top side of the beam splitter 17) travels once from the first major external surface 11a to the second major external surface 11b when propagating within the LOE 11 by internal reflection.

This set length L of the partially reflective surface 17a of the beam splitter 17 minimizes interference patterns caused by light corresponding to a point in the image striking the partially reflective surface 17a of the beam splitter 17 more than once prior to entering the LOE 10 while maximizing illumination of the LOE 10.

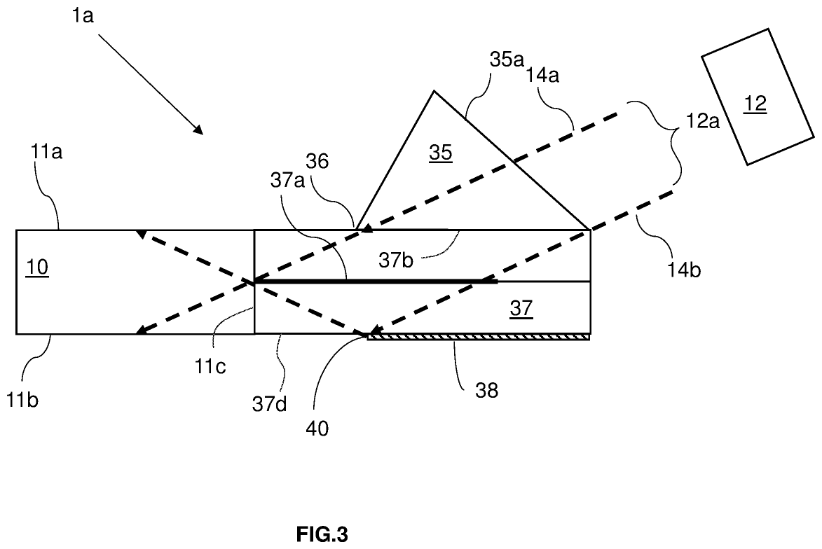

FIG. 3 illustrates a system 1a similar to the system 1 of FIG. 1 except the coupling prism 35 is placed on top of the beam splitter 37, thereby achieving simpler implementation at the tradeoff of a larger projector 12.

The system 1a includes the LOE 10 having mutually-parallel first and second major external surfaces 11a, 11b for guiding light therein by internal reflection and the light input surface 11c through which light enters the LOE 10. System 1a also includes a beam splitter 37 disposed adjacent to the light input 11c of the LOE 10. The beam splitter 37 has a partially reflective surface 37a, which is parallel to the first and second major external surfaces 11a, 11b of the LOE 10. The beam splitter 37 also has a coupling-in surface 37b through which light enters the beam splitter 37. System 1a also includes a projector 12 that projects light corresponding to an image (for example, a collimated image) and having a beam width 12a. System 1a also includes a coupling prism 35 that has an image injection surface 35a.

The projector 12 projects light corresponding to the image to be injected into the prism 35 via the image injection surface 35a. The injected beams (represented by the two extremes beams 14a and 14b) impinge on the image injection surface 35a of prism 35. Light travels through the prism 35 to the coupling-in surface 37b of the beam splitter 37. The partially reflecting surface 37a of the beam splitter 37 transmits a portion (e.g., 50%) and reflects a portion (e.g., 50%) of the light impinging thereon.

In this embodiment, the partially reflecting surface 37a is designed to have a length such that every light ray of the shallowest angle light in the angular field entering through the coupling-in surface 37b strikes the partially reflective surface 37a of the beam splitter 37 exactly once prior to entering the LOE 10 via the light input 11c to propagate within the LOE 10 by internal reflection. The length of the partially reflective surface 37a of the beam splitter 37 is such that a majority of light rays in the angular field transmitted through the coupling-in surface 37b impinge on the partially reflective surface 37a exactly once prior to entering the LOE 10 so as to propagate within the LOE 10 by internal reflection. Therefore, surface 37a acts as a splitter and not as a combiner. Consequently, coherent light can be injected into the lightguide without risk of generating coherent interference patterns.

System 1a may also include a light absorber 38 that trims excess light at one end of the range between 14a and 14b. The light absorber 38 is adjacent to a surface 37d of the beam splitter 37 opposite the coupling-in surface 37b. Trim location 40 (corresponding to the end of light absorber 38) is located directly opposing corner 36, which trims excess light at the other end of the range between 14a and 14b. Therefore, corner 36 and trim location 40 perform symmetrical trimming of the transmitted beams. In effect, a virtual plane is formed between corner 36 and location 40, defining the entrance pupil (herein also refer to as an aperture) into LOE 10.

While in system 1 of FIG. 1 the coupling-in surface 17b is at an oblique angle relative to the first and second major surfaces 11a, 11b, in the system 1a of FIG. 3, the coupling surface 37b is parallel to the first and second major surfaces 11a, 11b.

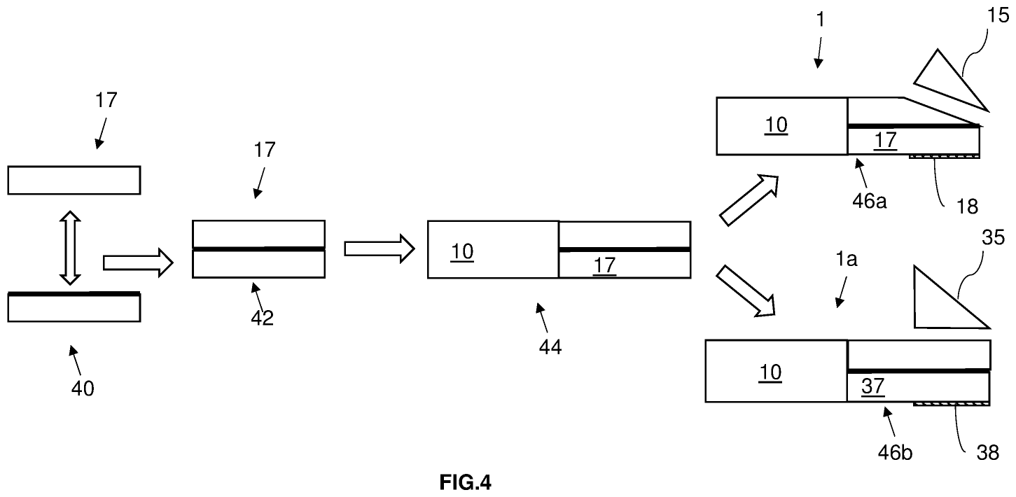

FIG. 4 illustrates an example process of manufacturing optical systems 1 and 1a. The plates at step 40 are coated with a partial reflector and attached together at step 42 to form the beam splitter 17. The attached plates forming the beam splitter 17 may be attached to the lightguide 10 at step 44 to be polished together and generate combined external facets. At step 46a the corner of the beam splitter 17 may be polished and prism 15 attached thereon. Alternatively, at step 46b, prism 35 may be attached directly on the lightguide face of the beam splitter 17 (now 37 since the corner is not removed).

At this stage absorbing coating may be applied to form the light absorbers 18 or 38.

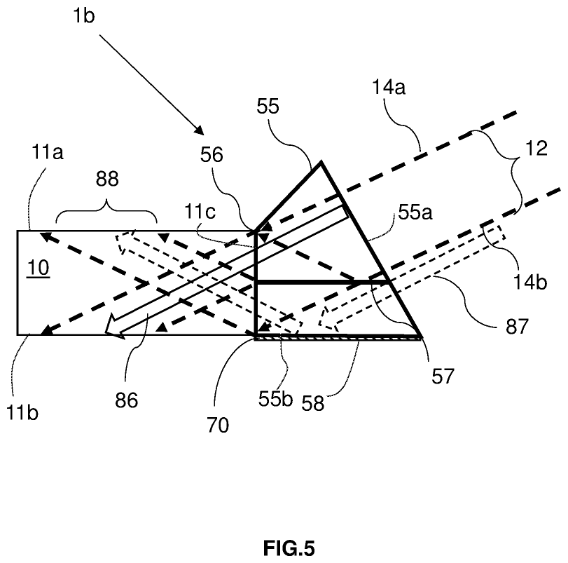

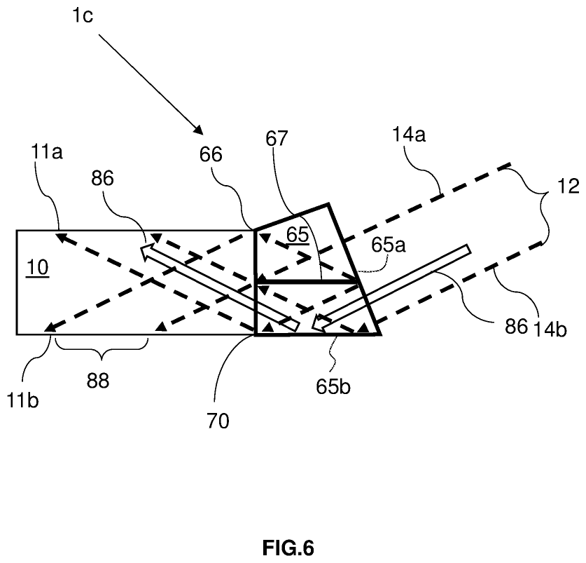

Further simplification of the beam splitting configuration may be achieved by implementing the partial reflector within the coupling prism and not as a separate part or as part of lightguide 10. This is shown in FIGS. 5 and 6.

In the system 1b of FIG. 5, partial reflector 57 is contained within prism 55, therefore it can be produced as a single element to be attached to lightguide 10. In this configuration, the light-beam 12 enters through the surface 55a and illuminates directly onto the aperture between 56 and 70. Here arrow 86 represents a direct beam (not experiencing split), therefore part of the illumination will have twice the intensity, while segment 88 shows an area where no light pass through (missing light shown as dashed arrow 87 outside the illuminator aperture 12). Therefore, in this configuration the illumination uniformity is reduced. Nevertheless, in some applications this non uniformity may be tolerable.

A light absorber 58 may be disposed adjacent to a second side 55b of the prism 55 opposite the input side 55a.

FIG. 6 illustrates a configuration 1c equivalent to FIG. 5 except the illumination is at the lower section of the aperture and the bottom face 65b of the prism 65 is reflective. The partial reflector 67 is contained within prism 65, therefore it can be produced as a single element to be attached to lightguide 10. In this configuration, the light-beam 12 enters through the surface 65a and illuminates directly onto the aperture between 66 and 70. Here arrow 86 represents a direct beam (not experiencing split), therefore part of the illumination will have twice the intensity, while segment 88 shows an area where no light passes through (missing light). Therefore, in this configuration the illumination uniformity is reduced. Nevertheless, in some applications this non uniformity may be tolerable.

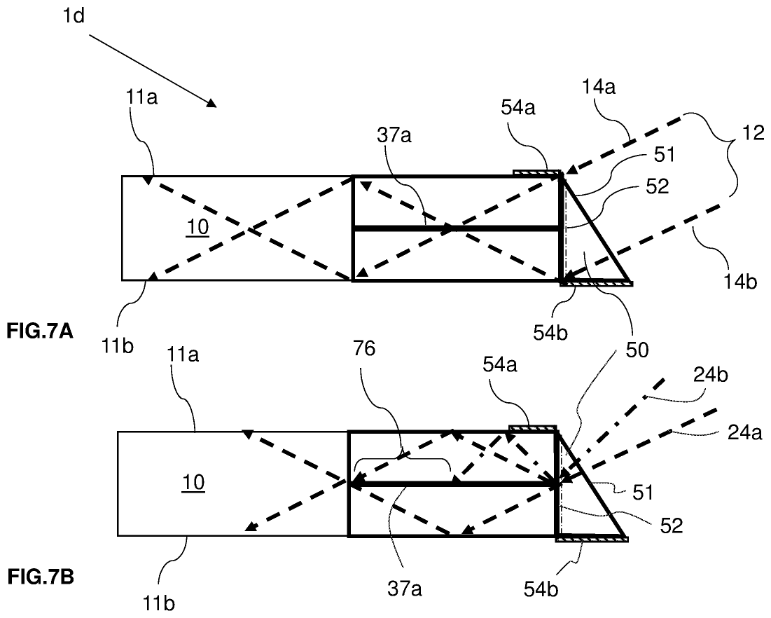

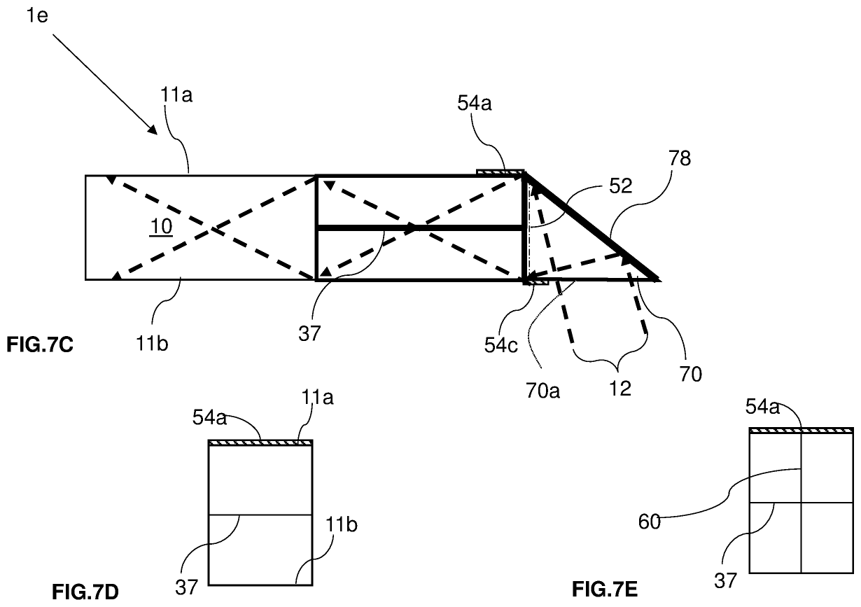

FIG. 7A shows a further simplified configuration 1d where the coupling configuration is limited to the width of LOE 10. Beams 14a, 14b enter the optical system 1d through blank prism 50 having perpendicular entrance surface 51 that serves to minimize aberrations. The exit from prism 50 and entrance to the LOE 10 serve as the entrance pupil 52. The projecting optics may be designed to have exit aperture overlapping this lightguide-entrance aperture 52. Aperture 52 is located very close to entrance surface 51, thereby enabling small projection optics. Stray light is trimmed-off at the entrance by optional absorbing surfaces 54a and 54b. In the first section of the LOE 10, the beams impinge once on partial reflector surface 37a therefore creating a uniform illumination of LOE 10.

FIG. 7B shows two central beams 24a, 24b at different angles (fields) where the dashed arrows 24a represent the shallowest and the dot-dashed 24b represents the steepest beam in the image. At least part of the steepest beam 24b impinges on partial reflector 37a twice. The extra length of surface 37a is marked as 76. Consequently, part of the field of the projected image could have interference patterns when using coherent illumination. As described in FIG. 1, the length of 37a can be set to be shorter at partially compromising illumination uniformity at the field edges.

While in the system 1 of FIG. 1 the coupling-in surface 17b is at an oblique angle relative to the first and second major surfaces 11a, 11b and in the system 1a of FIG. 3 the coupling surface 37b is parallel to the first and second major surfaces 11a, 11b, in the system 1d of FIGS. 7A and 7B, the coupling surface 52 is perpendicular to the first and second major surfaces.

Optional absorber 54a may be set so its end does not clip the steepest beam, as shown.

FIG. 7C illustrates an equivalent configuration 1e where the clear entrance prism is replaced with a reflecting prism 70 having a reflector 78. More optical components can be added (not shown) to suppress aberrations. The coupling-in surface 52 is perpendicular to the first and second major surfaces. The reflecting surface 78 may be attached to, coated on, or forming part of the coupling prism 70 such that light 12 injected through the image injection surface 70a is reflected by the reflecting surface 78 towards the coupling-in surface 52. In some embodiments, the reflecting prism 70 may be larger than the width of the lightguide 10.

In the case of a rectangular-cross-section lightguide, the clear prism 50, the reflector 70 and all the above prisms described, can be tilted out of the plane of the drawing in order to inject the light at an appropriate orientation.

FIG. 7D illustrates schematically a front view of an implementation of a rectangular lightguide where the splitter 37 is oriented laterally as described above.

FIG. 7E shows a further implementation of a perpendicular splitter 60 in addition to splitter 37. The vertical splitter 60 can be implemented in the clear prism 50, or in the reflecting prism 70. Alternatively, it can be implemented in the various beam splitters 17, 37, etc. in the above configurations.

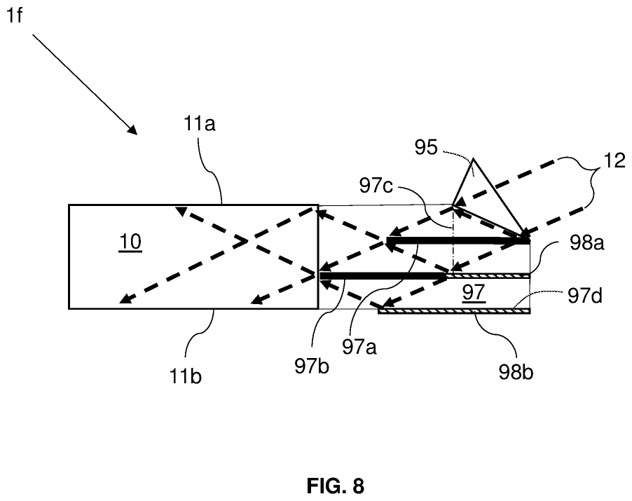

A beam splitter implemented with multiple partial reflectors may further improve system properties in terms of projector size, uniformity, and coupling section size. FIGS. 8, 9, and 10 illustrate systems incorporating multiple partial reflectors.

FIG. 8 illustrates a system 1f in which the beam splitter 97 includes two partial reflectors 97a, 97b, which serves to reduce the input aperture 97c. In one embodiment, partial reflector 97a has reflectivity of 33% while partial reflector 97b has reflectivity of 50%. In other embodiments, the partial reflectors 97a, 97b may have reflectivity different from 33% and 50%, respectively. In the embodiment of FIG. 8, partial reflector 97a is of the same length but shifted left relative to partial reflector 97b. The entrance pupil 97c is now smaller than the case of a single partial reflector as described in FIG. 1.

The positioning and reflectivity of partial reflectors 97a, 97b may be chosen to ensure uniform illumination of lightguide 10 for a nominal illumination angle. Light absorbers 98a, 98b may serve to absorb stray light. The absorbers 98a, 98b may be implemented simultaneously, separately, or not at all.

Advantages of a system 1f, with reduced size aperture 97c, may include the ability to use a smaller size prism 95 and/or smaller size projector 12.

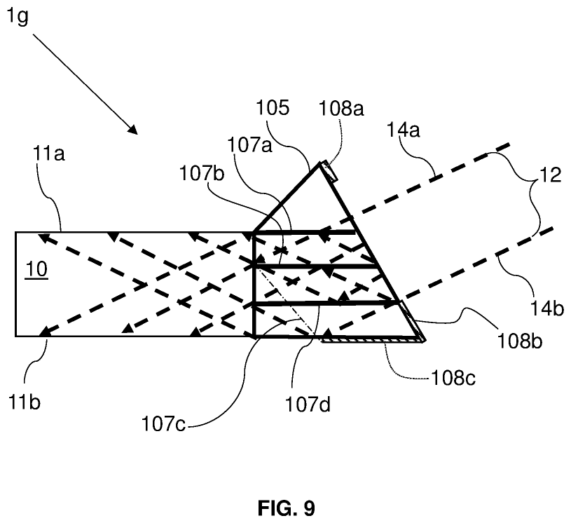

FIG. 9 illustrates a system 1g including a prism 105 including three partial reflectors 107a, 107b, and 107d contained therein to improve light uniformity in a simplified configuration equivalent to that of FIG. 5. Light absorber 108a, 108b, and 108c may be used to attenuate stray light. Various reflectivity values may be defined for partial reflectors 107a, 107b, 107d. In one embodiment, partial reflector 107a has a lower reflectivity than partial reflector 107d with partial reflector 107b having a reflectivity therebetween.

In this configuration, it is possible to define the input aperture 107c. The reflections from the partial reflectors 107a, 107b, 107d serve to shift the illumination to fill the lightguide 10. In this configuration, the light-beam 12 enters through the prism 105 and illuminates directly onto the aperture 107c.

In the system 1g, output illumination onto lightguide 10 is more uniform compared to the illumination of the systems shown in FIGS. 5 and 6. Here, all sections are illuminated uniformly. There are no blank segments 88 and no sections 86 that are fully illuminated as shown in FIGS. 5 and 6.

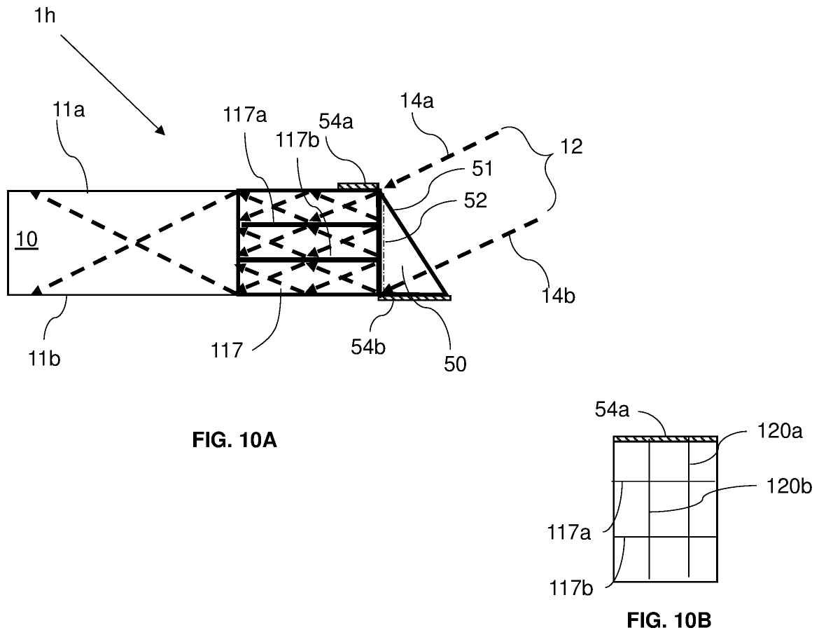

FIG. 10A illustrates a system 1h including a beam splitter 117 including two partial reflectors 117a, 117b in a configuration similar to that of FIG. 7A. The additional beam splitting caused by the additional partial reflector 117b enables a length reduction of the beam splitter 117 and partial reflectors 117a, 117b compared to the configuration of FIG. 7A. Beams 14a, 14b enter the optical system 1h through blank prism 50 having perpendicular entrance surface 51 that serves to minimize aberrations. The exit from prism 50 and entrance to the LOE 10 serve as the entrance pupil 52. The projecting optics may be designed to have exit aperture overlapping this lightguide-entrance aperture 52. Aperture 52 is located very close to entrance surface 51, thereby enabling small projection optics. Stray light is trimmed-off at the entrance by optional absorbing surfaces 54a and 54b. Light beams impinge once on partial reflector 107a, 107b therefore creating a uniform illumination of LOE 10.

FIG. 10B illustrates schematically that the beam splitter 117 may also include vertical partial reflectors 120a, 120b in addition to the horizontal partial reflectors 117a, 117b.

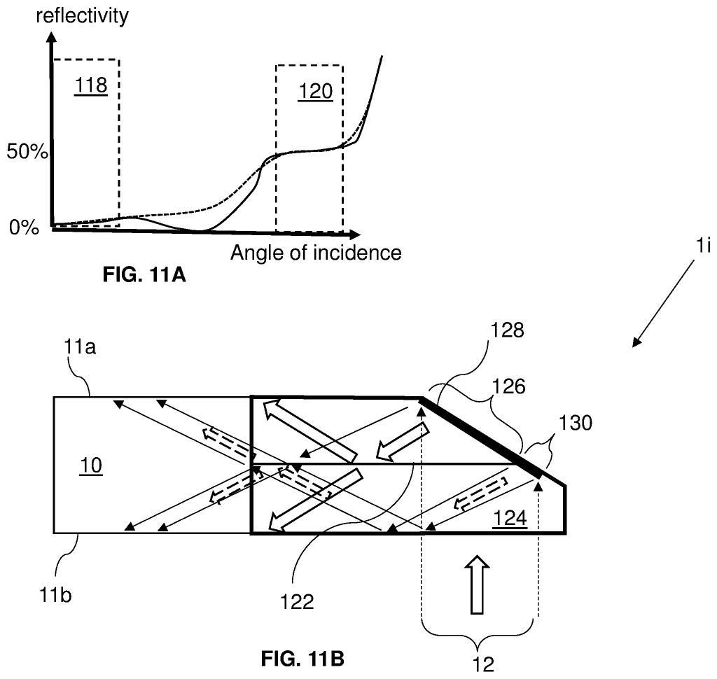

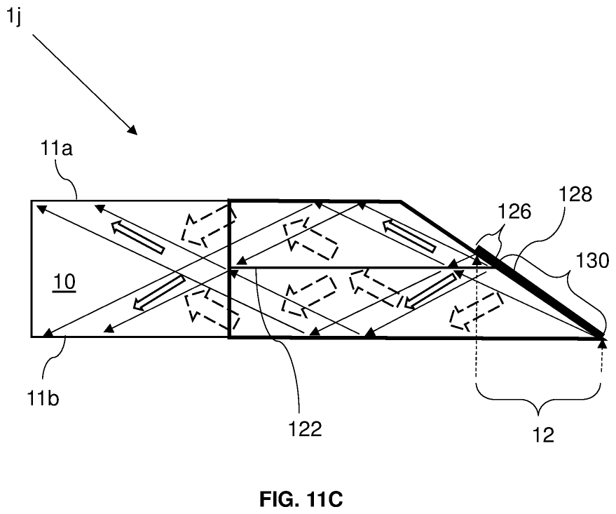

FIGS. 11A and 11B illustrate an implementation of a single prism that serves both as reflector (mostly due to ergonomic considerations) and a single reflection beam splitter.

FIG. 11A graphically illustrates the reflectivity profile of a dielectric coating having minimal reflectivity at low angles 118 and 50% reflectivity at high angles 120. This coating is implemented in the configuration shown in FIG. 11B as splitting surface 122 of system 1i. The impinging beam having width 12 (boundaries marked as dashed arrows) enters the prism 124 at low angle (within range 118). Part of the beam 12 impinges on splitting surface 122 and therefore passes it with minimal loss. This part is reflected by section 126 of plane reflector 128 onto the lightguide 10 (large solid arrows). Light that does not pass though splitter 122 illuminates the plane reflector 128 at section 130 to be reflected at the same angle. This light is marked as dashed thick arrows. The reflections (solid and dashed arrows) are the same and continuous. They are separated here for clarity of the description.

The illumination from section 126 impinges on splitter 122 at high angle 120 and is therefore split as shown. The reflection from section 130 is first reflected from the end of prism 124 (can be also referred to as face of lightguide 10) before impinging on the end of splitting surface 122 at high angle 120 and is therefore also split in two as shown. By proper selection of the width of reflector 128 and the length of the splitter 122, a uniform and complete illumination of lightguide 10 may be achieved. The fact that a single prism 124 including splitter 122 and reflector 128 (if needed top and bottom reflectors may be implemented as well as continuation of lightguide 10 external faces) enables simple and low-cost production of a folding and splitting arrangement.

FIG. 11C illustrates a system 1j in which the reflector 128 of FIG. 11B is placed at any location along the same plane. Illumination 12 illuminates all this reflector 128, therefore the output will be uniform while only the relative width of 126 and 130 will change. In this figure, the reflector 128 is moved to the lowest location (optimal for reducing optics size and production simplicity), consequently the illumination from 126 is smaller than the illumination from section 130. This configuration may include more splitters, thereby enabling narrower incident beam 12 and optics.

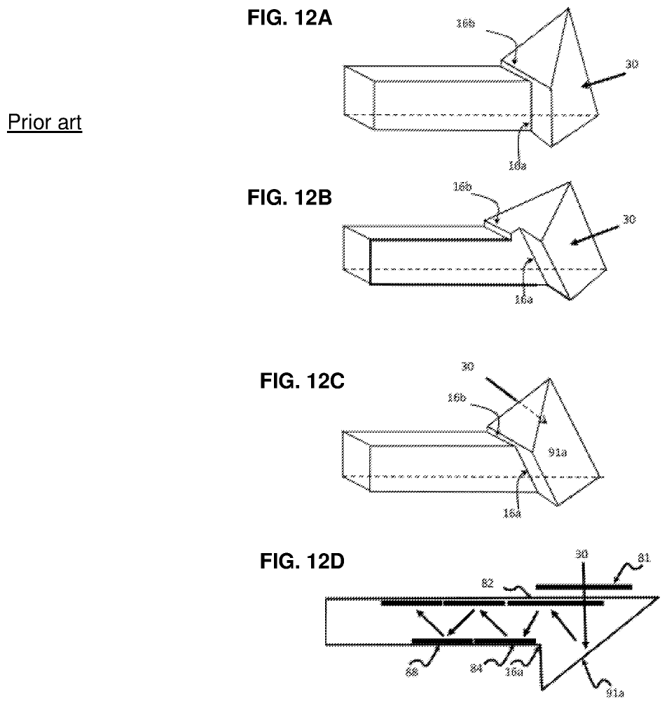

In a further embodiment, two dimensional lightguides include two sets of parallel faces, perpendicular to each other. Coupling into these rectangular cross section lightguides is described in U.S. Pat. No. 10,564,417. FIGS. 12A-12D illustrate various configurations of coupling based on refractive and reflective optics as disclosed in the '417 patent. The coupling arrangement includes trimming edges: 16a and 16b. The beam splitting configurations described in FIGS. 1 to 11 of the present disclosure can be combined to generate optimal coupling light to such 2D lightguides. The aperture can be reduced in one or two dimensions.

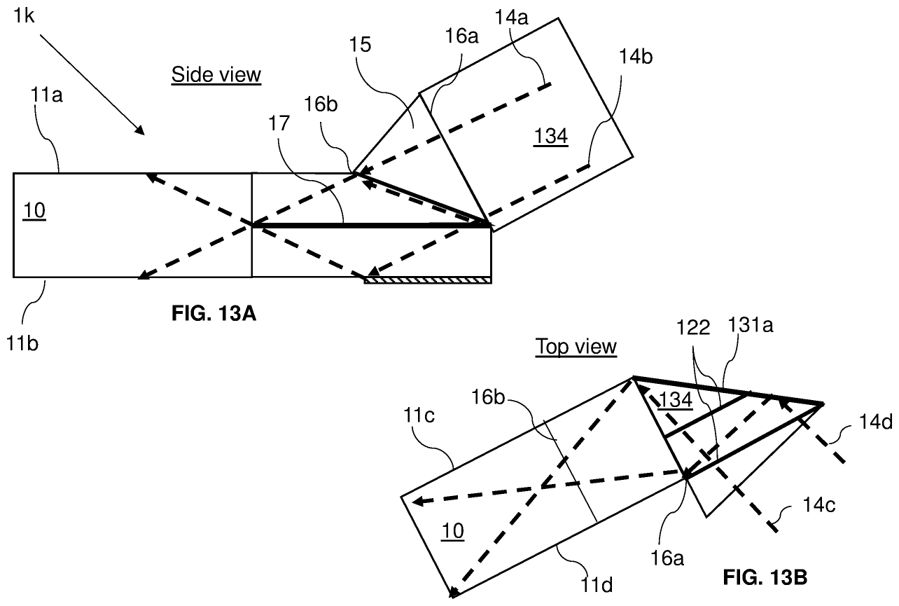

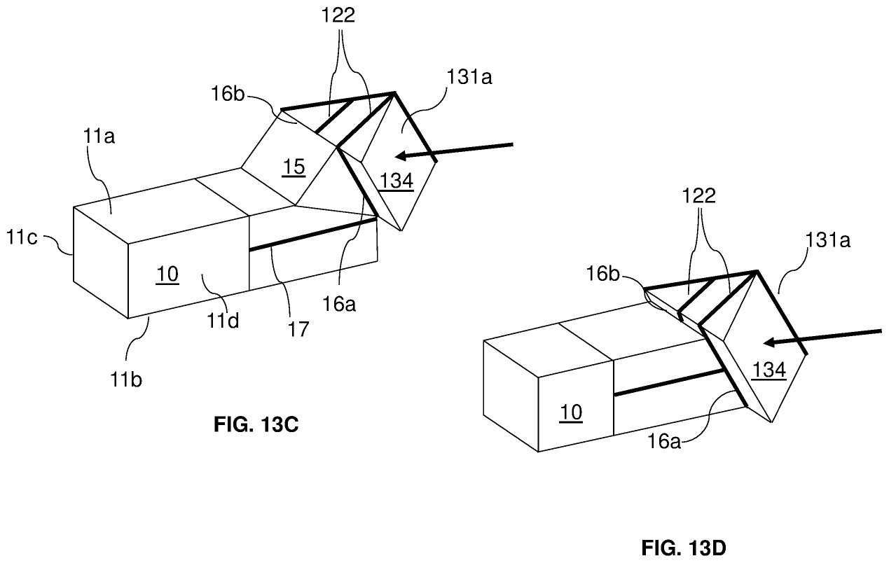

FIGS. 13A, 13B and 13C illustrate side, top, and isometric views, respectively, of a system 1k of coupling into a 2D lightguide based on combining reflecting prism 134 into a configuration similar to that of FIG. 1. Light (beams 14a-d) enter prism 134 to be reflected by reflecting surface 131a onto lightguide 10. The entrance aperture is defined in one dimension by 16a and the other dimension by 16b. Partial reflector 17 enables reduction of aperture vertically (as described for FIG. 1) while making it possible to also include partial reflectors 122 (having the profile of FIG. 11A) in prism 134 as described in FIG. 11B (or in FIG. 9 but here as reflecting prism).

FIG. 13D illustrates a simplified configuration where reflecting prism 134 attaches directly to the lightguide 10 without prism 15.

Beam splitting by crossing partial reflectors as shown in FIG. 10B is possible in all the above configurations, while the separate approach as described in FIG. 13 simplifies the production process by making the splitters as independent components.

The absorbers described in the above configurations can be replaced with prisms or other refractive components that couple the light out of the respective system.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1.-33. (canceled)

34. An optical system, comprising:
a light-guide optical element (LOE) formed from a transparent material having a light input and mutually-parallel first and second major external surfaces for guiding the light by internal reflection;
a coupling prism adjacent to a coupling-in surface, the coupling prism comprising:
an image injection surface, and
at least one partially reflective surface contained within the coupling prism and positioned adjacent the light input, the at least one partially reflective surface parallel to the first and second major external surfaces; and
a projector being associated with the image injection surface and configured to project light corresponding to a collimated image from an aperture, the light exiting the aperture with a chief ray defining an optical axis of the projector with an angular field about the chief ray,
wherein the projector being oriented such that the chief ray and at least some of the angular field about the chief ray are injected through the image injection surface, some rays corresponding to the angular field partially reflected and some partially transmitted by the partially reflective surface prior to entering the LOE.

35. The optical system of claim 34, further comprising:
a light absorber disposed adjacent to a bottom surface of the prism with an end adjacent the light input.

36. The optical system of claim 34, wherein the prism has a bottom surface that is reflective and the projector is configured such that a majority of light from light rays injected through the image injection surface impinges on the at least one partially reflective surface exactly once.

37. The optical system of claim 34, wherein a length dimension of the at least one partially reflective surface minimizes interference patterns caused by light corresponding to a point in the image striking the at least one partially reflective surface more than once prior to entering the LOE.

38. The optical system of claim 34, wherein the at least one partially reflective surface contained within prism comprises a first partially reflective surface and a second partially reflective surface, each of the first and second partially reflective surfaces parallel to the first and second major external surfaces.

39. The optical system of claim 38, wherein the prism further contains within a third partially reflective surface parallel to the first and second major external surfaces.

40. The optical system of claim 34, wherein the at least one partially reflective surface has applied thereon a dielectric coating having different reflectivity to (a) light impinging thereon at low angles relative to the at least one partially reflective surface and (b) light impinging thereon at high angles relative to the at least one partially reflective surface, high angles being larger relative to the at least one partially reflective surface than low angles, the optical system further comprising:
a reflecting surface attached to or forming part of the coupling prism and disposed relative to the at least one partially reflective surface such that a portion of light injected through the image injection surface first passes the at least one partially reflecting surface and is thereafter reflected by the reflecting surface towards the at least one partially reflecting surface and a portion of light injected through the image injection surface does not first pass the at least one partially reflective surface is reflected by the reflecting surface towards the second major external surface.

41. An optical system, comprising:
a two-dimensional light-guide optical element (LOE) formed from a transparent material having a light input, a first set of mutually-parallel faces, and a second set of mutually-parallel faces, wherein the first and second sets of mutually-parallel faces are perpendicular relative to each other;
a coupling prism adjacent to a coupling-in surface, the coupling prism comprising:
an image injection surface, and
at least one partially reflective surface contained within the coupling prism and positioned adjacent the light input, the at least one partially reflective surface parallel to at least one of the first set of mutually-parallel faces or the second set of mutually-parallel faces; and
a projector being associated with the image injection surface and configured to project light corresponding to a collimated image from an aperture, the light exiting the aperture with a chief ray defining an optical axis of the projector with an angular field about the chief ray,
wherein the projector being oriented such that the chief ray and at least some of the angular field about the chief ray are injected through the image injection surface, some rays partially reflected and partially transmitted by the at least one partial reflector contained with the coupling prism and the at least one partial reflector of the beam splitter are at an oblique angle relative to the first set of mutually-parallel faces and to the second set of mutually-parallel faces.

42. An optical system, comprising:
a light-guide optical element (LOE) formed from a transparent material having a light input and mutually-parallel first and second major external surfaces for guiding the light by internal reflection;
a coupling prism adjacent to a coupling-in surface, the coupling prism comprising an image injection surface, and a plurality of partial reflectors contained within the coupling prism and positioned adjacent the light input, each of the plurality of partial reflectors being parallel to the first and second major external surfaces; and
a projector being associated with the image injection surface and configured to project light corresponding to a collimated image from an aperture, the light exiting the aperture with a chief ray defining an optical axis of the projector with an angular field about the chief ray,
wherein the projector being oriented such that the chief ray and at least some of the angular field about the chief ray are injected through the image injection surface, some rays corresponding to the angular field partially reflected and some partially transmitted by at least one of the plurality of partial reflectors surface prior to entering the LOE.

43. The optical system of claim 42, wherein the coupling prism further contains a first partial reflector, a second partial reflector, and a third partial reflector.

44. The optical system of claim 43, wherein the first partial reflector has a lower reflectivity than the second partial reflector and wherein the second partial reflector has a lower reflectivity than the third partial reflector.

45. The optical system of claim 44, further comprising:
a first light absorber disposed adjacent to a bottom surface of the prism with an end adjacent the light input;
a second light absorber disposed adjacent to the image injection surface with an end adjacent to the bottom surface of the prism; and
a third light absorber disposed adjacent to the image injection surface with an end adjacent to a top surface of the prism.

46. The optical system of claim 42, wherein a length dimension of each of the plurality of partial reflectors minimizes interference patterns caused by light corresponding to a point in the image striking each of the plurality of partial reflectors more than once prior to entering the LOE.

47. The optical system of claim 42, wherein the LOE is a two-dimensional LOE, wherein the coupling-in surface is one of:
at an oblique angle relative to the first and second major surfaces,
parallel to the first and second major surfaces, and
perpendicular to the first and second major surfaces.

48. An optical system comprising:
a light-guide optical element (LOE) formed from transparent material and having a light input and mutually-parallel first and second major external surfaces for guiding the light by internal reflection;
a beam splitter disposed adjacent the light input and having at least one partial reflector parallel to the first and second major external surfaces and a coupling-in surface;
a coupling prism adjacent the coupling-in surface, the coupling prism comprising:
an image injection surface, and
at least one partial reflector contained within the coupling prism positioned perpendicular to the first and second major external surfaces, and wherein the at least one partial reflector is parallel to at least one external surface of the LOE; and
a projector configured to project light corresponding to a collimated image from an aperture, the light exiting the aperture with a chief ray defining an optical axis of the projector and with an angular field about the chief ray,
wherein the projector being oriented such that the chief ray and at least some of the angular field about the chief ray are injected through the image injection surface, some rays corresponding to the angular field partially reflected and some partially transmitted by the at least one partial reflector contained within the coupling prism and the at least one partial reflector of the beam splitter prior to entering the LOE.

49. The optical system of claim 48, further comprising:
a light absorber disposed adjacent to a bottom surface of the beam splitter.

50. The optical system of claim 48, wherein the coupling prism further comprises a reflecting surface disposed on a side of the prism opposite the image injection surface.

51. The optical system of claim 48, wherein the LOE further comprises mutually-parallel third and fourth major external surfaces, the mutually-parallel third and fourth major external surfaces being perpendicular to the mutually-parallel first and second major external surfaces; and
wherein rays partially reflected and partially transmitted by the at least one partial reflector contained with the coupling prism and the at least one partial reflector of the beam splitter are at an oblique angle relative to the mutually-parallel first and second major external surfaces and to the mutually-parallel third and fourth major external surfaces.

52. The optical system of claim 48, wherein the length dimension of the of the at least one partial reflector of the beam splitter minimizes interference patterns caused by light corresponding to a point in the image striking the at least one partial reflector of the beam splitter more than once prior to entering the LOE.

53. The optical system of claim 48, wherein the length dimension of the at least one partial reflector contained within the prism minimizes interference patterns caused by light corresponding to a point in the image striking the at least one partial reflector of the prism more than once prior to entering at least one of the beam splitter or the LOE.
